(19) United States
(12) Patent Application Publication
(10) Pub. No.: US 2007/0024422 A1
(43) Pub. Date: Feb. 1, 2007

(54) Systems and methods for personnel security identification using adapted portable data storage and display devices

(75) Inventor: William George Doyen, Annapolis, MD (US)

Correspondence Address: OLIFF & BERRIDGE, PLC, P.O. BOX 19928, ALEXANDRIA, VA, 22320, US

(73) Assignee: ARINC INCORPORATED, Annapolis, MD (US)

(21) Appl. No.: 11/189,733

(22) Filed: Jul. 27, 2005

(51) Int. Cl. G05B 19/00

(52) U.S. Cl. 340/5.81; 340/5.82

(57) ABSTRACT

The disclosed systems and methods may provide a portable data storage and display device such as, for example, an Electronic Flight Bag (EFB), usable to query stored or remote databases containing personal identification information regarding individuals so that images presented on a display unit of the device may be visually compared with characteristics of the individual, and/or individual identification documents that the individual presents. Available images may include pictures of individuals, examples of standard identification forms, and/or biometric identifying data for comparison such as, for example, fingerprint scans and retinal scans. Users may be provided an ability to access flight crew or airline personnel rosters, law enforcement personnel rosters, “no-fly/barred” passenger lists and/or other “persons of interest” lists immediately from an aircraft to verify individual identification providing another layer of personnel security verification and defense, particularly.in mass transit and airline applications.

### BACKGROUND

This disclosure is directed to systems and methods for implementing personnel security identification procedures through a portable data storage and display device. Exemplary systems and methods are particularly useful for providing a convenient resource for personnel security identification verification by an individual user, particularly in mass transportation scenarios, using an Electronic Flight Bag (EFB).

Security concerns, and particularly capabilities related to personnel security identification verification in mass transportation applications, have become very high priorities since the tragedies of Sep. 11, 2001. Security efforts have been enhanced in and around, for example, airports. These security efforts involve layers of defense from curbside check-in to the doorway where passengers depart the air terminal and proceed to the aircraft. At a plurality of checkpoints such as, for example, ticketing, baggage check-in, specific security checkpoints, and the terminal gate door, individual forms of personal identification, issued by a recognized authority, are visually inspected and verified. Additionally, airlines, governmental entities, law enforcement agencies and other organizations maintain detailed lists of their own personnel, as well as lists of persons of interest to the individual company, entity, agency and/or organization. These lists may include personnel rosters for the respective agencies and/or organizations, often including very detailed information regarding, and photographic identification of, the individuals. On the other hand, information regarding individuals who have been highlighted to the company, entity, agency and/or organization as persons regarding whom there is some reason for concern may also be compiled and stored for ready reference. In this latter category, there generally exist lists of, for example, “no-fly” or “barred” passengers, who have been identified as individuals to whom access to mass transportation, particularly aircraft, should be denied.

The sheer volume of individuals to be checked, confounded by attempts by persons of interest to conceal their identities, requires that individuals involved in the security hierarchy be afforded ever more sophisticated capabilities by which to verify personnel security identification information, and to be able to spot persons of interest and/or identification forms that may have been altered, without unduly hampering the flow of individuals through the transportation systems. With the specific applications related to airports and commercial aircraft, very often the layers of defense, while formidable, end when a passenger or passengers pass through the door of the gate exiting the air terminal toward the aircraft. At least here, a void exists in current multi-layered security efforts, because, to date, security measures have not been effectively extended into the aircraft where security is most important.

Other concerns or areas for increased vigilance in air transportation include the fact that on many occasions individual members in a flight crew may not have met before the flight. In such an instance, it may be possible for an individual attempting to perpetrate some wrongdoing to take an identity card of a crew member, alter the identity card, as necessary, to impersonate the crew member, and thereby gain access to, and potentially control of, the aircraft.

U.S. patent applications Ser. Nos. 10/919,318 and 10/971,104, as well as U.S. patent application Ser. No. (Attorney Docket No. 123072, hereinafter “the ′072 reference”), commonly assigned and incorporated herein in their entirety by reference, describe advantageous uses being made of portable data storage and display devices, to streamline, make more efficient, and/or make safer, operations that require relatively immediate access to a particular individual data reference page contained in volumes of stored data reference pages, which could number in the tens of thousands of such individual pages, depending on the applications and uses assigned to the data reference pages. The above-described applications describe a suite of products related specifically to the use of Electronic Flight Bags (EFBs) that are carried in the cockpits of, and otherwise within, modern aircraft. In many applications, EFBs can be advantageously employed to provide an integrated, user-friendly interactive platform, through which routine tasks requiring access to data for time-critical data recall, data manipulation, crew coordination and real-time communication to myriad remote receiving nodes, may be performed. This allows a user to interact with others in an effective manner. Communication methodologies employing portable data storage and display devices, as is taught by the ′072 reference, will be referenced throughout the disclosure, but the details of those methods will not be exhaustively repeated herein.

The above-referenced applications explain that the introduction of EFBs into the cockpits of modern aircraft has afforded an automated and interactive library of publications in an electronic format to replace the conventional flight bag full of checklists, charts, publications and the like. EFBs were originally designed to provide specific data reference pages as may be required to cover individual aircraft operations from preflight through postflight, but capabilities have been added to these portable data storage and display devices to undertake myriad other tasks. EFBs can provide a library of the tens of thousands of required documents incumbent to safe and effective operations of the aircraft, such as charts and checklists covering normal, special and/or emergency procedures that may be encountered during flight. The EFB can be commanded to display information as either static “information only” data reference pages, and/or interactive data reference pages, individually available via user input to select from among the volumes of data stored within the device. The EFB can also be used as a pathway to provide integrated data communications and exchange capabilities to myriad remote receiving nodes.

These portable data storages and display devices may offer large storage capacities, various imaginative finctionalities assigned to individual data reference pages to display data in textual and graphical formats, and the ability for a user to interact with the device and the data stored therein.

### SUMMARY

The scope of methodologies and capabilities for manipulating pages of data resident in a portable data storages and display device or for coordinating actions external to the device via any manner of internal and/or connectible automated or manual input/output interface continues to increase. As such, the capabilities resident in these portable data storage and display devices, of which an EFB is an individual example, are virtually limitless.

In the face of a more persistent and sophisticated threat, there exists a more extensive law enforcement presence on board routine commercial air traffic today. Verification of such an authorized presence may assist in quickly identifying law enforcement agents and individuals for consultation and/or action should a threat situation arise.

It would be advantageous to provide another layer of security defense even within the cockpit and/or cabin of a commercial airline or other aircraft. Such a system could be employed to provide further personnel information identification for verification of, for example, flight and cabin crew and/or airline personnel, embarked law enforcement personnel, and potentially to further identify passengers, and specifically, persons of interest, including individuals attempting to conceal their true identities who may have avoided being caught by the layers of personnel security defenses available in, for example, the airport terminal.

Various exemplary embodiments of disclosed systems and methods provide a portable data storage and display device such as, for example, an Electronic Flight Bag (EFB) that may be employed to query stored or remote databases containing personal identification information regarding individuals or groups of individuals. The query may result in an image being presented on a display unit of the portable data storage and display device, and a user may visually compare the image with the characteristics of the individual and/or individual identification documents that the individual presents. Images available to be drawn from a personal identification information database may include pictures of individuals, examples of standard identification forms, and/or biometric identifying data for comparison such as, for example, fingerprint scans and retinal scans.

Various exemplary embodiments of the disclosed systems and methods may provide individual users an ability to access flight crew or airline personnel rosters, law enforcement personnel rosters, “no-fly/barred” passenger lists, and/or “persons of interest” lists immediately from an aircraft in order to attempt to determine whether individuals are who they represent themselves to be.

Various exemplary embodiments of the disclosed systems and methods may add another layer of security in an aircraft, implemented via a portable data storage and display device that includes at least one personal information identification database and/or an ability to access information contained in, for example, law enforcement and/or organizational personal identification information databases. Such a capability may enhance personnel security, and safe and efficient operations, of, for example, commercial aircraft through the addition of another layer of personnel security.

In various exemplary embodiments of the disclosed systems and methods, a capability may be incorporated into current or later-developed EFB products to enable individuals such as, for example, flight crew members and/or cabin attendant personnel, to be provided with an interactive catalog of stored reference materials designed to facilitate personnel security identification verification in and around aircraft. An EFB, or EFB-like electronic security notebook device, may be loaded with a face book, or other pictorial roster, of, for example, airline personnel, law enforcement personnel, known “no-fly/barred” passengers, and/or other “persons of interest.” Information regarding individuals presenting themselves as either flight crew members or law enforcement personnel, or trying to hide their identities as persons of interest, may be readily provided to individual users in an updateable, portable and interactive form.

Various exemplary embodiments of disclosed systems and methods may provide an ability to recognize passengers in, on and/or around aircraft by various methods such as facial recognition, optical recognition or other biometric methods and to attempt to match observed characteristic with information contained in a database of personal identification information that may include known persons of interest. Biometric data sources or recognition devices may be placed in or near an entrance to an aircraft to communicate via a compatible biometric data communication interface with the portable data storage and display device. Visual and/or automated comparisons between input information and stored information within the device may be provided.

At present, most individual personnel identification is undertaken by visually verifying an individual's appearance with that which is presented on some form of standard printed identification form. A library of images regarding how each such printed identification form should look (blank and/or filled-in), with the potential for reference to certain individual data fields, may also be provided. Such standard identification forms may include, for example, state-issued driver's licenses, federal, state or local government-issued identification cards, U.S. or foreign government-issued passports, or any organizationally-issued form of identification. Individual data fields of interest may include, for example, dates of issue, identification numbers, types, donor information, bar codes, addresses, or classes, as applicable.

Various exemplary embodiments of disclosed systems and methods may provide an updateable capability to compare individual identification forms presented by an individual, to a visual data reference page containing a copy of the individual identification form as it should appropriately appear overall, or at least with respect to one or more of the data fields on the form. This database may be compiled and stored within the portable data storage and display device based on inputs from, for example, government agencies, governments and/or organizations that produce the individual identification forms. An individual user of the portable data storage and display device may be provided an image regarding how, for example, a particular state's driver's license should look taking into account the standard in use at the time of issue. Such a capability may make it easier for the individual user to compare the form of identification presented with that shown on the display unit of the portable data storage and display device in order to identify forgeries, alterations and the like.

Various exemplary embodiments of disclosed systems and methods may provide a capability whereby at least one password is required to access data. Dual encryption codes such as, for example, one half being input by a pilot and the other half being input by a co-pilot, may alternatively be required to provide security for the system in order that access to the system and available databases is restricted.

In various exemplary embodiments, disclosed systems and methods may include a capability to allow the portable data storage and display device to control, via an appropriate data communications link, clear and/or encrypted access to governmental or other databases containing information regarding categories of personnel identified above.

Various exemplary embodiments of disclosed systems and methods may provide an updateable capability that allows a given airline, organization or other entity the ability to maintain and/or update its own database of, for instance, frequent or repeat travelers or other individuals in a given category.

Various exemplary embodiments of disclosed systems and methods may be described herein to refer to a specific application where security in and around aircraft is enhanced by the accessibility of portable data storage and display devices containing personal identification information databases to, for example, flight crew members and cabin attendant personnel. Further, the exemplary embodiments may describe a communications capability originating in such portable data storage and display devices by which an individual user may access personal identification information databases at remote sites in order to enhance the security of air traffic. These exemplary embodiments are intended to be illustrative rather than limiting. Disclosed systems and methods should not be construed as limited to any individual application. Rather, such devices are usable in any mass transportation and/or large crowd control and/or personnel identification verification scenario in order to provide an ability to effectively, and often in a time-critical manner, compare visual and/or biometric identifiers and/or documents regarding presented individuals with a database of such information. The database may be available either within the device or at a remote receiving node with which the device is capable of communicating.

These and other features and advantages are described in, or apparent from, the following detailed description of various exemplary embodiments of disclosed systems and methods.

### BRIEF DESCRIPTION OF THE DRAWINGS

Various exemplary embodiments of disclosed systems and methods will be described in detail with reference to the following figures, wherein:

FIG. 1 illustrates an exemplary embodiment of a system within which a portable data storage and display device for communicating to enhance personnel security access to personnel databases for verification of information is provided;

FIG. 2 illustrates a block diagram of an exemplary embodiment of a generic portable data storage and display device, of which an EFB is one specific example, usable with the disclosed systems and methods as adapted to provide ready access to personal identification information databases stored within the device or available at remote receiving nodes;

FIG. 3 illustrates a first operating view of an EFB as an example of a portable data storage and display device usable with the systems and methods according to this disclosure;

FIG. 4 illustrates a second operating view of the EFB of FIG. 3;

FIG. 5 illustrates a third operating view of the EFB of FIG. 3; and

FIG. 6 illustrates a fourth operating view of the EFB of FIG. 3.

### DETAILED DESCRIPTION OF EMBODIMENTS

The following description of various exemplary embodiments will describe systems and methods for enhancing personnel security in and around aircraft and/or airports by providing ready access to a plurality of individual personal identification information databases for personnel identification verification. The discussion will focus on currently available EFB devices as platforms for storing and/or providing such access to the information and databases. However, it should be appreciated that the disclosed principles, as outlined and/or discussed below, are not to be so narrowly construed. The disclosed systems and methods may find equal utility with any portable and/or hand-held, electronic and/or digital, data storage and display device which can store at least one database containing personal identification information, to which may be connected at least one biometric data source, and through which a communication link may be established for data transmission to and reception from a remotely-located personal identification information database.

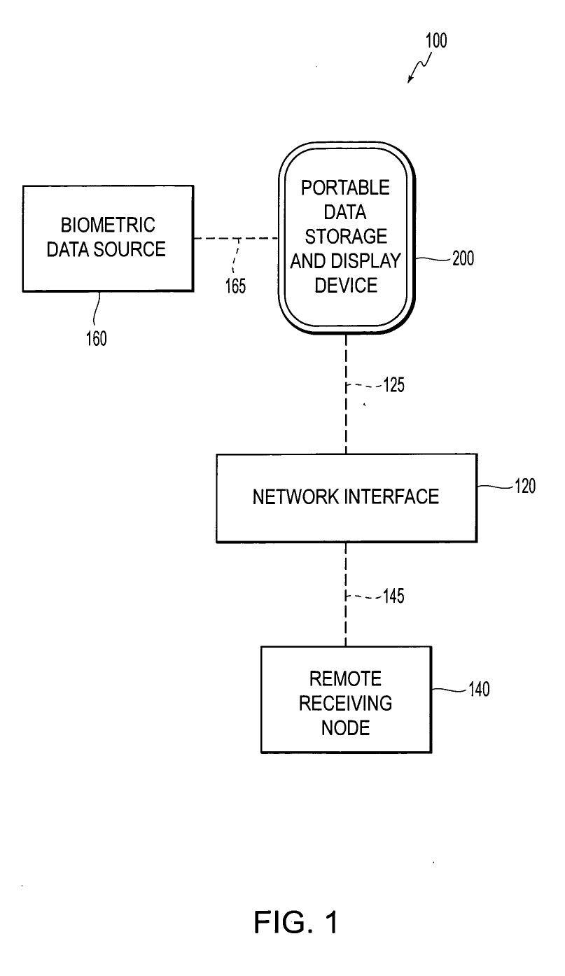

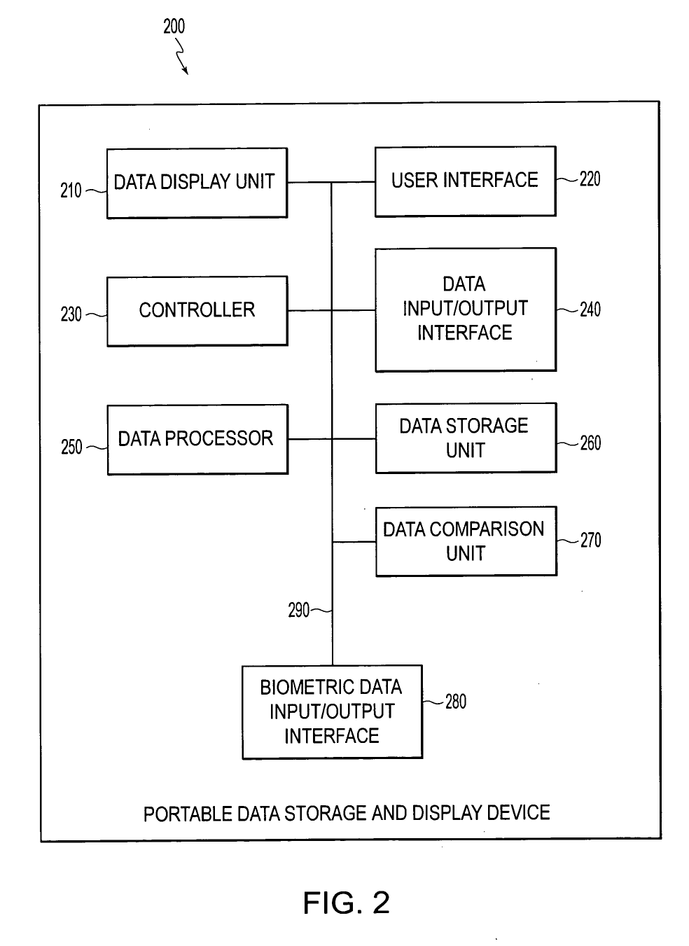

FIG. 1 illustrates an exemplary embodiment of a system 100 within which a portable data storage and display device 200 for communicating to enhance personnel security access to personnel databases for verification of information is provided. As shown in FIG. 1, the system 100 may include an individual user's portable data storages and display device 200. An Electronic Flight Bag is a specific example of such a portable data storage and display device 200. Details of an EFB and of a generic portable data storage and display device 200, according to this disclosure, will be described below with reference to FIGS. 2-6.

The portable data storages and display device 200 may be capable of communicating with at least a network interface 120 via a communications path 125. The network interface 120 may be available to compatibly integrate communications with at least one remote receiving node 140 via the same communications path 125, or a separate communications path 145. Although depicted as a separate interface device, the network interface 120 may be housed within either the portable data storages and display device 200 or the remote receiving node 140. When so located, the depicted separate communications paths 125 and 145 could be a single communications path. Additionally, the exemplary data communications paths represent any now known or later-developed connection that supports data transfer between a portable data storage and display device and an external communications capability and/or receiving nodes. The data communications connections may include, for example, any form of wired, wireless or optical communications connections, or any combination of those, between communicating elements.

The network interface 120 may include, for example, a network connection or a wireless fidelity (WiFi) connection in order to provide a pathway by which data communicated from an individual portable data storages and display device 200 may be transmitted to a remote receiving node 140 and data available at the remote receiving node 140 may be provided back to the portable data storages and display device 200, either independently of, or on request from, the portable data storages and display device 200.

The remote receiving node 140 may constitute any device or unit with which communications can be established in order to, for example, query a database of personal identification information which is overseen and/or maintained by, for example, an organization responsible for maintaining the remote receiving node 140. Alternatively, the system may be used to automatically report verification of the identification of an individual's identification, as information regarding the individuals whereabouts, authorized or unauthorized, to such a remote receiving node 140 as an alert to the remote organization. Examples of these organizations may include airlines, other companies, governmental entities and/or law enforcement agencies.

Additionally, the system 100 may incorporate a capability for accessing biometric data from at least one exemplary biometric data source 160 via a separate communications path 165 to the portable data storages and display device 200. Such a biometric data source 160 may include, but not be limited to, a fingerprint scanner, a retinal scanner, a document scanner, a video camera, a still image camera, a blood pressure monitor, a pulse monitor, a height measuring device and/or a scale. It is contemplated that virtually any now known or future-developed capability by which some individual form of biometric data is obtainable could be employed as a biometric data source 160 to input such biometric data to the system 100 and specifically to the portable data storages and display device 200.

FIG. 2 illustrates a block diagram of an exemplary embodiment of a generic portable data storage and display device 200, of which an EFB is one specific example, usable with the disclosed systems and methods to provide ready access to personal identification information databases stored within the device and/or available at remote receiving nodes, such as remote receiving node 140 depicted in FIG. 1.

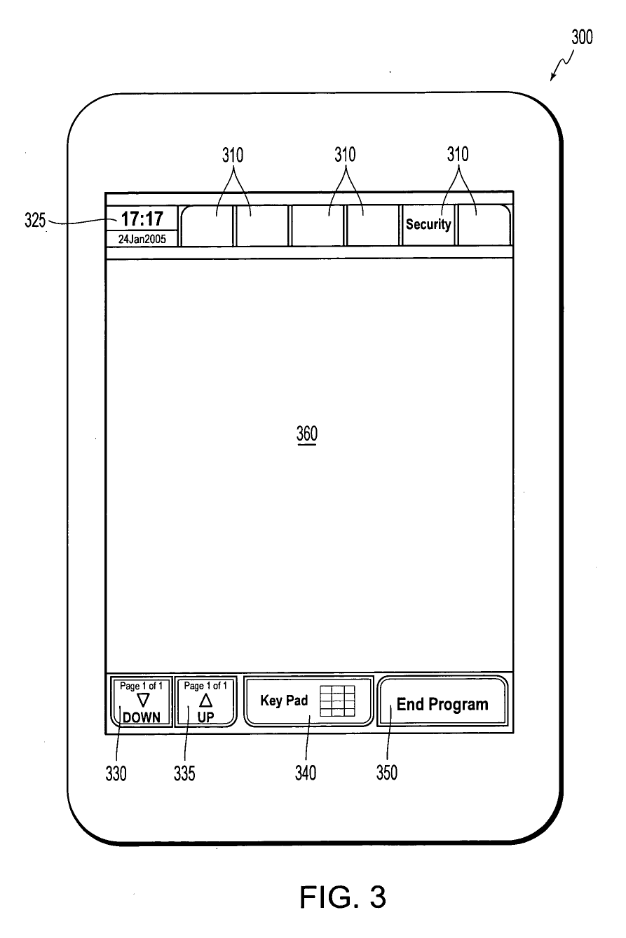

In the following discussion, a generic portable data storage and display device 200 is described with reference to FIG. 2. Then below, with reference to FIGS. 3-6, the description will turn to exemplary embodiments of an EFB as an example of a portable data storage and display device 200. Although described in this manner, it should be appreciated that an EFB is a particularly optimized form of a portable data storage and display device 200 as contemplated by this disclosure. The systems and methods are not intended, however, to be limited to any specific device or any specific configuration within such a device.

The data storage and display device 200 depicted in FIG. 2 includes a data display unit 210, a user interface 220, a controller 230, a data input/output interface 240, a data processor 250, at least one data storage unit 260, a data comparison unit 270, and a biometric data input/output interface 280. Each of these components may be interconnected via the data/control bus 290.

It should be appreciated that although shown as individual components within a single exemplary data storage and display device 200, individual functionalities may be importable from a separate portable or fixed data storage device via, for example, the network input/output interface 240. Individual finctionalities may also be combined within individual devices housed within the portable data storage and display device 200, or may be provided by devices external to the portable data storage and display device 200. For example, if the biometric data source 160 depicted in FIG. 1 formats the data in a manner recognizable by the portable data storage and display device 200, such data may be input to the portable data storage and display device 200 via the data input/output interface 240 rather than by a separate biometric data input/output interface 280. The user interface 220 may be integral to the data display unit 210 such as, for example, in a configuration wherein the user interface 220 includes a touch-screen display on the data display unit 210.

Additionally, each of the individual components, although depicted as being interconnected via a data/control bus 290 in an apparent hard-wired configuration, may be usable to communicate with each of the other components via any communications path by which data may be transferred between the individual components whether, for example, wired, wireless and/or optical, or by any combination thereof.

All operations of the data storage and display device 200 may be controlled via the controller 230, and information may be displayed to the user on the data display unit 210.

In various exemplary embodiments of disclosed systems and methods, biometric data may be received from at least one biometric data source 160 as depicted in FIG. 1, and input to the portable data storage and display device 200 via the biometric data input/output interface 280 or otherwise, as described above. The data processor 250 may cause the data comparison unit 270 to compare received biometric data with stored biometric data retrievable from, for example, a data storage unit 260, and to display on the display unit 210 any recognizable graphical representation of the results of the comparison.

The data storage unit 260 may be available to store at least one database containing personal identification information which may be individually programmed into the portable data storage and display device 200 via the user interface 220, or may be downloaded or uploaded from a separate source via, for example, the data input/output interface 240.

The data storage unit 260 may be available to, for example, store at least one database containing personal identification information to include, but not be limited to, a face book or other pictorial roster of individuals whose personal identification information is stored within the portable data storages and display device 200. A user may manipulate the user interface 220 in a manner as will be described in more detail below in order that stored images of individuals′pictures may be displayed on the display unit 210 retrieved from a database stored in the data storage unit 260. The data storage unit 260 may be available to alternatively store personal identification information regarding standard forms of identification documents issued by organizations and/or agencies (private, commercial or governmental). Upon user manipulation of the user interface 220 a standard form may be retrieved from the data storage unit 260 and displayed on the digital display unit 210. In this manner, a user can compare the pictorial representation of the standard form of identification, either in its entirety or with respect to certain defined fields, with the like form of identification provided by the individual under observation. One example of such comparison may include observation of an individual state's standard form driver's license, or state-provided identification card, in order to ascertain whether the form of the presented identification is valid. In such an instance, individual data fields of interest may include, for example, dates of issue, identification numbers, types, donor information, bar codes, addresses, or classes, as applicable.

All of the information required to support the functionalities as described above, and as will be outlined below, may be resident in a portable data storage and display device 200 such as, for example, an EFB. Alternatively, the data storage and display device 200 may be usable primarily as an input/output device to coordinate access to personal identification information databases stored in a local or remote server or other like device, to include those housed at at least one remote receiving node such 140, as is depicted in FIG. 1. Additionally, it should be recognized that the information contained in any database housed within the data storage unit 260 may require routine update. Such update may, for example, be performed through communication with a remote database via the data input/output interface 240 and, if necessary, through a network interface 120, as depicted in FIG. 1.

Any data storage contemplated for the various disclosed exemplary embodiments may be implemented using an appropriate combination of alterable memory or fixed memory. The alterable memory, whether volatile or non-volatile, may be implemented using any one or more of static or dynamic RAM, a hard drive, flash memory or any other memory medium and/or device. Such memory device or unit is contemplated to be internal to the portable data storage and display device 200. Such configuration, however, is not intended to be limiting. Additional data storage space may include alterable memory externally connected with the exemplary individual portable data storage and display device 200, such as, for example, an external disk drive with associated disk-type medium. Similarly, the fixed memory can be implemented using any one or more of ROM, PROM, EPROM, EEPROM and optical ROM disk which may be implemented using a compatible, connected disk drive, or internal disk drive, or any other memory storage medium and/or device.

The processing described herein occurs primarily internal to the exemplary portable data storage and display device 200 running applications designed to execute user-directed storage, recovery and comparison of personal identification information stored in at least one database. Optionally, such processing could occur by providing control inputs from a portable data storage and display device 200 to a separate data storage device with associated control elements resident within, for example, a local or remote server. Further, it should be appreciated that the processing outlined in the disclosed systems and methods can be implemented through software algorithms, hardware or firmware circuits, or any combination of software, hardware and/or firmware control elements, present in a portable data storage and display device 200, of which an EFB is an example.

FIG. 3 illustrates a first operating view of an EFB 300 as an example of a portable electronic data storage and display device usable with the systems and methods according to this disclosure. As shown in FIG. 3, the exemplary EFB 300 may include a plurality of individual application buttons 310. For the purposes of executing an application such as that disclosed herein, an individual application button 310 marked, for example, “SECURITY” may be provided in order to allow a user to initiate a personnel identification verification scheme. Individual pages of data may be scrolled through using exemplary UP and DOWN buttons 330/335. Other specific function buttons which are generic to many applications may include, for example, a KEYPAD button 340 and an END PROGRAM button 350. A real-time clock 325 for real-time date and time display, and a primary data display region 360 on the display unit of the EFB 300 may be provided.

Manipulation of the SECURITY button 310 may activate the personnel identification verification scheme and/or signal the user's intent to interact with a personal identification information database stored within a data storage unit resident within the exemplary EFB 300, or to attempt to establish communication with a remote receiving node for access to a remote personal identification information database stored at the remote receiving node.

It should be appreciated that none of the depictions in FIGS. 3-6 are intended to be limiting. They are rather intended to show one exemplary embodiment for implementing the systems and methods according to this disclosure via an exemplary EFB 300.

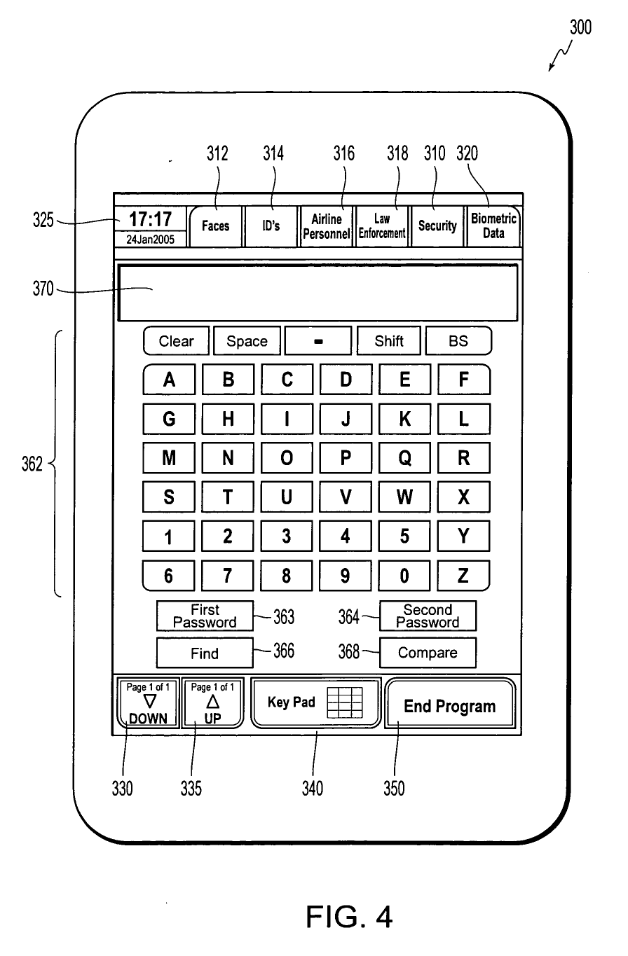

Once within a personnel identification verification scheme (hereinafter “a security mode”) of the exemplary EFB 300, a user may, for example, operate the keypad button 340 in order to transition the primary display area 360 to a keypad display, shown in exemplary manner in FIG. 4.

FIG. 4 illustrates a second operating view of the EFB of FIG. 3. As shown in FIG. 4, an exemplary security mode display may include an alpha-numeric keypad 362 by which a user may input specific information required in order to query the database stored within a device or a remote database, or both. An exemplary data reference field 370 may be provided in order that the user can verify the input information. Examples of specific access to individual functionalities or categories of information stored within a personal identification information database may include, for example, a FACES button 312 usable to display in the primary data display region 360 (see FIG. 3) a pictorial representation of an individual for whom personal identification information is stored in a database. An ID's button 314 may be available to allow the user to access a catalog of standard identification forms for display in the primary display region 360 (see FIG. 3).

Individual organizations may provide information regarding their own personnel or other persons of interest which may be accessible as specified lists such as, for example, lists which are accessible through manipulation of an AIRLINE PERSONNEL button 316 or a LAW ENFORCEMENT button 318. Additionally, for entering a mode of operation in the EFB whereby biometric data may be imported, and manually or automatically compared, a BIOMETRIC DATA button 320 may be available.

Combined with the above finctionalities, there may be provided a capability whereby at least a first password, or at least first and second password, are required to access information stored within the exemplary EFB 300. A FIRST PASSWORD button 363 and a SECOND PASSWORD button 364 may be made available as a portion of a user interface displayed in the primary display region 360 (see FIG. 3) of the exemplary EFB 300. These buttons 363, 364 may allow the user to enter a password, and/or other encryption key, as may be required to access the capabilities and/or information stored within the EFB 300.

Other finctionalities may be provided via the user interface. For example, an individual code or other descriptor for the for the display of information may be input by the user manipulating the alpha-numeric keypad 362. Information in the data reference field 370 may be verified. Then the user may manipulate the FIND button 366 causing the EFB to search the stored database, or to query a remote database, in an effort find the individual identified by the keyed input. Additionally, a COMPARE button 368 may provide the user the ability to manually initiate a comparison between stored data fields and remote data fields, or stored biometric data and biometric data as may be received from a biometric data source.

Information can be entered into the device in any manner, and interaction may be undertaken with at least one stored or remote database through manipulation of exemplary functioning, as depicted in FIGS. 3 and 4.

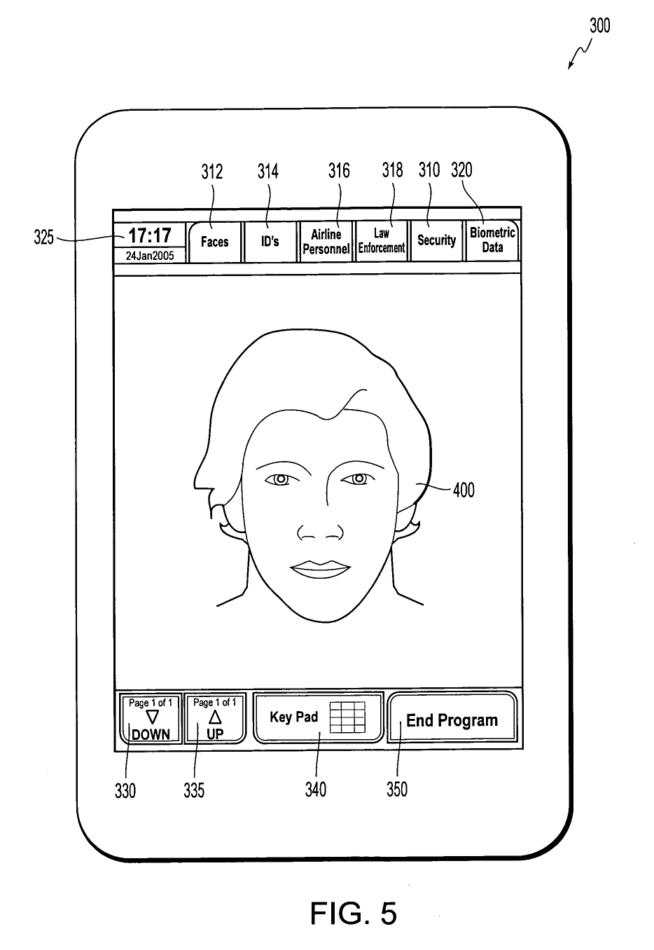

FIG. 5 illustrates a third operating view of the EFB of FIG. 3. As shown in FIG. 5, the user has implemented the FACES or other visual identification capability resident within the exemplary EFB 300 via, for example, activating the FACES button 312. In this manner, and based on any identifying information which individual user provides to the device, one or more pictures of an individual or individuals, which may be associated with the input information, may be recalled from the stored personal identification information database and displayed as a visual image 400 in the primary display region 360 (see FIG. 3) of the exemplary EFB 300. Display of such a visual image 400 facilitates visual comparison between the displayed visual image 400 and the characteristics of the individual whose identification is being verified by this process.

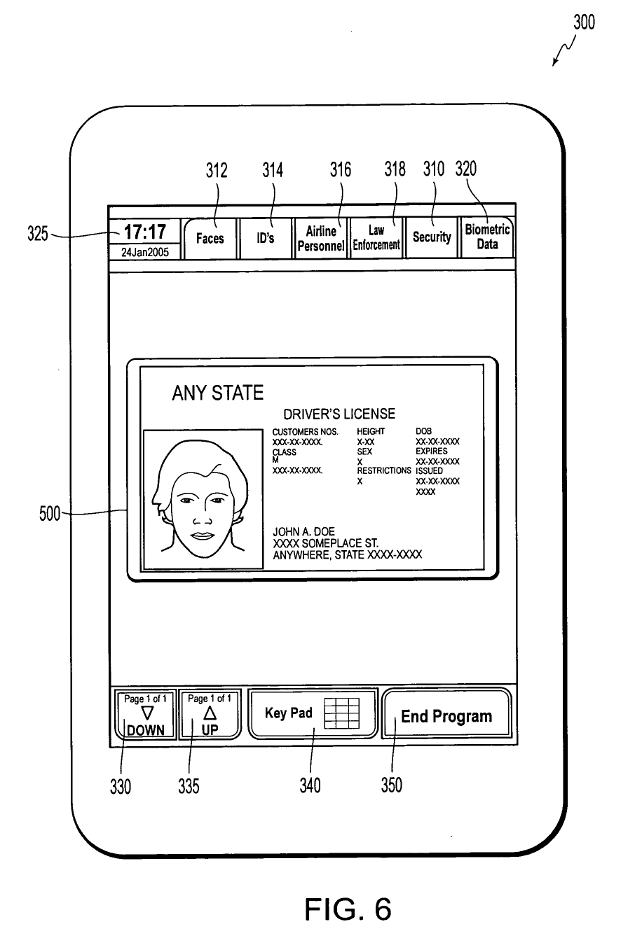

FIG. 6 illustrates a fourth operating view of the EFB 300 of FIG. 3. As shown in FIG. 6, through separate manipulation of, for example, the ID's button 314, a standard form of identification, based on user input via, for example, the exemplary alpha-numeric keypad 362 depicted in FIG. 4, an image of a standard identification form 500, depicted as an ANY STATE driver's license, may be displayed to facilitate visual verification between the standard identification form presented by the individual whose identification is intended to be verified and an image of a standard identification form 500 retrieved from a stored database of standard identification forms available in a personal identification information database. The personal identification information database may be resident within the exemplary EFB 300 or available from a remote receiving node with which the exemplary EFB 300 may communicate.

While exemplary embodiments have been described above, these exemplary embodiments should be viewed as illustrative, and not limiting. Various modifications, substitutes, or the like are possible within the spirit and scope of this disclosure.

What is claimed is:

1. A data reference and personnel security identification system, comprising:
a portable data storage and display device that includes:
a data storage unit that stores a plurality of interactive data reference pages and separately stores at least a first database containing personal identification information;
a data display unit that displays at least one of (i) the plurality of interactive data reference pages or (2) personal identification information requested by a user from the at least first database, the displayed personal identification information facilitating comparative verification of an identity of an individual based on a comparison of the individual with the displayed personal identification information;
a user interface that allows a user to select from among the plurality of interactive data reference pages, and to interact with the first database;
a data input/output interface for at least one of transmitting or receiving data related to personnel identification output from or input to the portable data storage and display device; and
a data processor that processes at least one of user inputs received through the user interface or data inputs from the data input/output interface, and that drives the display unit to display user-selected information,
wherein the portable electronic data storage and display device is usable to facilitate visual identification of individuals.

2. The system of claim 1, wherein the portable electronic data storage and display device is an Electronic Flight Bag.

3. The system of claim 1, wherein at least some of the plurality of interactive data reference pages contain information comprising at least one of aircraft navigational data, aircraft procedures checklists or aircraft operating manuals.

4. The system of claim 1, further comprising a network interface that facilitates transmission and reception of available information the data input/output interface to and from at least one remote receiving node, wherein the network interface comprises at least one of wired, wireless or optical data communications connections between the portable data storage and display device and the network interface.

5. The system of claim 4, wherein the at least one remote receiving node stores at least a second database containing personal identification information.

6. The system of claim 5, wherein the at least the second database is at least one of a personnel or a persons-of-interest database maintained by at least one of an airline, a corporation, a governmental entity or a law enforcement agency.

7. The system of claim 5, wherein the at least second database comprises a database of standard identification document forms.

8. The system of claim 5, wherein personal identification information can be retrieved from the at least the second database based on a user request for the information through the user interface of the portable data storage and display device, the retrieved information being at least one of displayed on the display unit of the portable data storage and display device or stored in the data storage unit of the data storage and display device for later recall.

9. The system of claim 5, wherein personal identification information can be recalled from the first database stored in the portable electronic data storage and display device and transmitted to the at least second database stored at the at least one receiving node.

10. The system of claim 1, wherein the personal identification information contained in the first database includes visual images of individuals.

11. The system of claim 10, wherein the comparative verification of the identity of the individual is based on a comparison between a visual image of the individual presented on the data display unit and the physical appearance of the individual to the user.

12. The system of claim 1, wherein the personal identification information contained in the first database includes standard identification document forms.

13. The system of claim 12, wherein the comparative verification of the identity of the individual is based on a comparison between a standard identification document form presented on the data display unit and documents presented by the individual to the user.

14. The system of claim 12, wherein the comparison comprises review of a discrete data field on the document, the discrete data field comprising at least one a date of issue, an identification number, a record of donor information, a bar code, an address, a type or a class.

15. The system of claim 1, further comprising a biometric information input interface for receiving data from at least one biometric data source.

16. The system of claim 15, wherein the at least one biometric data source comprises at least one of a fingerprint scanner, a retinal scanner, a document scanner, a video camera, a still image camera, a blood pressure monitor, a pulse monitor, a height measuring device or a scale.

17. The system of claim 15, wherein the personal identification information contained in the first database includes personal biometric data.

18. The system of claim 17, wherein the comparative verification of the identity of the individual is based on a comparison between stored personal biometric data regarding the individual retrieved from the first database and presented on the data display unit, and biometric data regarding the individual received from the at least one biometric data source.

19. The system of claim 17, wherein the portable data storage and display device further comprises a biometric data comparison device for automatically comparing personal biometric data regarding the individual retrieved from the first database and biometric data regarding the individual received from the at least one biometric data source.

20. The system of claim 19, wherein only a graphical indication of the results of the comparison are displayed on the display unit.

21. The system of claim 1, wherein the user interface is integral to the data display unit.

22. The system of claim 1, wherein the user must enter at least one of a password or an encryption key to at least one of activate the system or access the at least first database.

23. The system of claim 22, wherein more than one password or encryption key must be entered.

24. The system of claim 4, wherein results of the comparative verification of the identity of the individual can be transmitted automatically to at least one remote receiving node.

25. A method for personnel security identification, comprising:
storing at least a first database containing personal identification information in at least one portable data storage and display device that stores a plurality of interactive data reference pages and the at least first database;
recalling personal identification information from the at least first database in response to a user manipulating a user interface of the portable data storage and display device;
displaying on a display unit of the portable data storage and display device the recalled information to enable a user to compare the recalled information with that presented by an individual to be verified for security purposes.

26. The method of claim 25, wherein the portable data storage and display device is an Electronic Flight Bag.

27. The method of claim 25, wherein at least some of the plurality of interactive data reference pages contain information comprising at least one of aircraft navigational data, aircraft procedures checklists or aircraft operating manuals.

28. The method of claim 25, further comprising communicating personnel security information with a remote receiving node, wherein communication with the remote receiving node is initiated via user manipulation of the user interface on the portable data storage and display device, data transfer occurring via a compatible network interface.

29. The method of claim 28, wherein at least a second database is maintained at the remote receiving node, the at least second database comprising at least one of a personnel or a persons of interest database maintained by at least one of an airline, a corporation, a governmental entity or a law enforcement agency.

30. The method of claim 28, wherein personal identification information can be recalled from the at least first database stored in the portable data storage and display device and transmitted to the at least second database stored at the at least one remote receiving node.

31. The method of claim 25, wherein the personal identification information contained in the at least first database includes visual images of individuals.

32. The method of claim 31, wherein the comparison is between a visual image of the individual presented on the data display unit and the physical appearance of the individual to the user.

33. The method of claim 25, wherein the personal identification information contained in at least the first database includes standard identification document forms.

34. The method of claim 33, wherein the comparison is between a standard identification document form presented on the data display unit and documents presented by the individual to the user.

35. The method of claim 33, wherein the comparison comprises review of a discrete data field on the document, the discrete data field comprising at least one a date of issue, an identification number, a record of donor information, a bar code, an address, a type or a class.

36. The method of claim 25, further comprising obtaining biometric information from at least one biometric data source directly by the portable data storage and display device.

37. The method of claim 36, wherein the at least one biometric data source comprises at least one of a fingerprint scanner, a retinal scanner, a document scanner, a video camera, a still image camera, a blood pressure monitor, a pulse monitor, a height measuring device or a scale.

38. The method of claim 36, wherein the personal identification information contained in the at least first database includes personal biometric data.

39. The method of claim 38, wherein the comparison is between stored personal biometric data regarding the individual retrieved from the at least first database and presented on the data display unit, and biometric data regarding the individual received from the at least one biometric data source.

40. The method of claim 39, wherein the biometric data is automatically compared to the individual personal biometric data retrieved from the first database and biometric data regarding the individual received from the at least one biometric data source, and only a graphical indication of the results of the comparison is presented on the display unit of the portable data storage and display device.

41. The method of claim 25, further comprising receiving input of at least one of a password or other encryption key to at least one of activate the system or access the at least first database.

42. The method of claim 28, wherein communicating personnel security information with a remote receiving node comprises communicating results of the comparison of the recalled information with that presented by the individual to be verified for security purposes, wherein the communicating results of the comparison is at least one of manually initiated by the user or automatically initiated by the system.

43. A storage medium on which is recorded a program for implementing the method of claim 25.
